(19) United States
(12) Patent Application Publication
(10) Pub. No.: US 2016/0247174 A1
(43) Pub. Date: Aug. 25, 2016

(54) SYSTEMS AND METHODS FOR GENERATING DYNAMIC SPEND RANGES

(71) Applicant: MASTERCARD INTERNATIONAL INCORPORATED, Purchase, NY (US)

(72) Inventors: James E. Carrington, Greenwich, CT (US); Matthew Sordi, Sandy Hook, CT (US); Stephen Dantu, Armonk, NY (US); Divyam Mayawala, White Plains, NY (US)

(73) Assignee: MASTERCARD INTERNATIONAL INCORPORATED, Purchase, NY (US)

(21) Appl. No.: 14/629,733

(22) Filed: Feb. 24, 2015

(51) Int. Cl. G06Q 30/02

(52) U.S. Cl. CPC G06Q 30/0204

(57) ABSTRACT

Systems and methods of providing dynamically calculated spend ranged segmentations are disclosed. Payment account transaction data is selectively chosen based upon time of payment, whether the payment account associated with a portable consumer device is activated, account type, and geographic location where each account was issued. Outputs are thereby produced demonstrating spend ranges within certain categories evidencing affluence.

### FIELD OF TECHNOLOGY

The present disclosure relates generally to payment card transaction data and, more particularly, to generating current distributions of spend amounts among payment card market segments.

### BACKGROUND

Various market segmentation schemes categorize consumer, industrial, and business customers to guide strategic and tactical decision-making for sales and marketing purposes. Government agencies, industry associations, and businesses use standardized segmentation schemes for statistical surveys, or may create their own segmentation schemes to meet their particular needs.

The various market segmentation schemes are used to identify significant differences among current and potential customers that may influence their purchase decisions or buying behavior. This allows vendors, service providers and marketers to more effectively differentiate their prices, advertising programs, products and service offerings among the various market segments.

### SUMMARY

An aspect of the present disclosure describes a system for generating dynamic spend ranges, in which payment account data that includes an amount spent by each of at least two accounts is retrieved and organized into segments using common characteristics including account type and issuance location. According to this aspect of the present disclosure, the system also includes the calculation of spend bands for each of the segments using amount spent by each of the at least two accounts, and further creating auto-format groupings for the spend bands. The groupings adjust subsequently received transaction data to comport with the spend bands. In an embodiment, the spend bands are represented as percentiles. According to another embodiment, the spend bands include percentile ranges of top 1%, next 3%, next 5%, next 8%, next 12%, next 21%, and bottom 50%. In at least one embodiment, the account types includes credit, debit, consumer, and commercial accounts. According to an additional embodiment of the disclosure, the spend bands within each of the segments are gapless. In another embodiment, the issuance location includes continent, country, state, county, and city.

Another aspect of the present disclosure includes a method of generating dynamic spend bands. According to this aspect, payment account data having common characteristics including account type and issuance location is received. According to aspects of the present disclosure, the payment account data is ranked into segments using the common characteristics and spend bands within each of the segments are calculated based upon amount spent per payment account. Further according to this aspect, auto-format groupings using the spend bands are created. The auto-format groupings adjust subsequently received transaction data to comport with the spend bands. In an embodiment of the present disclosure, the spend bands within each of the segments are gapless. In at least one embodiment, the account type includes credit, debit, consumer, and commercial accounts. In a further embodiment, the issuance location includes continent, country, state, county, and city. According to yet another embodiment, the payment account data includes data from the past calendar year.

Another aspect of the present disclosure includes a method for generating dynamic spend bands. The method includes receiving transaction data from a payment card network, sorting the transaction data into segments based upon transaction type, sorting the transaction data by amount spent within each of the segments, determining a number of transactions within each spend percentile in each of the segments, and defining spend bands for each segment. In at least one embodiment, the transaction type includes a geographic region, type of product purchased, credit, debit, commercial, or consumer transactions. According to another embodiment, the spend bands are gapless within each of the segments. In yet another embodiment, the geographic region includes continent, country, state, county, and city.

Additional features and advantages of the present disclosure are described below. It should be appreciated by those skilled in the art that this disclosure may be readily utilized as a basis for modifying or designing other structures, systems and processes for carrying out the same purposes of the present disclosure. It should also be realized by those skilled in the art that such equivalent implementations do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The particular features and advantages of the present disclosure will be apparent from the detailed description set forth below in conjunction with the drawings in which like reference characters identify corresponding aspects throughout.

FIG. 1 is a conceptual block diagram illustrating a general example of a payment device transaction system according to aspects of the present disclosure.

FIG. 2 is a conceptual block diagram illustrating a general example of a dynamic spend range generation system according to aspects of the present disclosure.

FIG. 3 is a table including an example of dynamic spend bands generated by processing transaction data according to aspects of the present disclosure.

FIG. 4 is a process flow diagram illustrating a method for generating a dynamic spend bands based on transaction data according to aspects of the present disclosure.

FIG. 5 is a process flow diagram illustrating a method for generating a dynamic spend bands based on transaction data according to aspects of the present disclosure.

### DETAILED DESCRIPTION OF EMBODIMENTS

The detailed description set forth herein makes reference to the accompanying drawings, which show various aspects of the present disclosure by way of illustration. While these various aspects are described in sufficient detail to enable those skilled in the art to practice the disclosure, it should be understood that other embodiments and implementations may be realized and that logical and mechanical changes may be made without departing from the scope of the disclosure. Thus, the detailed description herein is presented for purposes of illustration only and not of limitation. For example, the steps recited in any of the method or process descriptions may be executed in any order and are not limited to the order presented. Moreover, references to a singular embodiments may include plural embodiments, and references to more than one component may include a singular embodiment, for example.

According to aspects of the present disclosure, payment card transaction data are processed to generate a set of dynamic spend ranges for different categories including different geographic areas, different payment card types and different transaction categories. The dynamic spend ranges may include selected percentiles of payment card accounts based on their annual spend amounts in a selected category. Upper and lower annual spend amounts for the selected ranges and categories are dynamically determined.

The dynamic spend ranges generated according to aspects of the present disclosure may be used to gauge the spending habits of different categories of account holders such as consumer credit card account holders, consumer debit card account holders and commercial credit card account holders, for example. The dynamic spend ranges may be used to determine the distribution of total annual spend amounts among a cardholders population and/or to determine a distribution of annual spend amounts for selected spending categories, among the cardholder population for example. Selected spending categories may include categories of products or services purchased, for example.

The dynamic spend ranges generated according to aspects of the present disclosure can be used to analyze the geographic distribution of spend levels for different market segments. Because spending behavior in certain market segments varies across geographic regions, the dynamic spend bands can be used by marketers, including banks and as payment card service providers, to more appropriately target their marketing campaigns and service offerings.

In order to create dynamic spend ranges for a particular segment of spending account or transaction type, total annual spend amounts for each payment card account in the segment may be collected from a database of payment card transaction data. A segment may include a particular card type or particular geographic region, for example. The payment card transaction data may then be sorted by account in order of amount spent in the corresponding account during a predetermined or selected period such as the previous year. Upon sorting the accounts data, the accounts may be arranged into dynamic spend bands. For example, according to an aspect of the present disclosure accounts may be arranged into selected percentiles of accounts based on amount spent during the predetermined or selected period. Actual spend amounts for the highest and lowest account in each selected range provide dynamic characterization of the spend bands that accurately define the spend distribution for the segment.

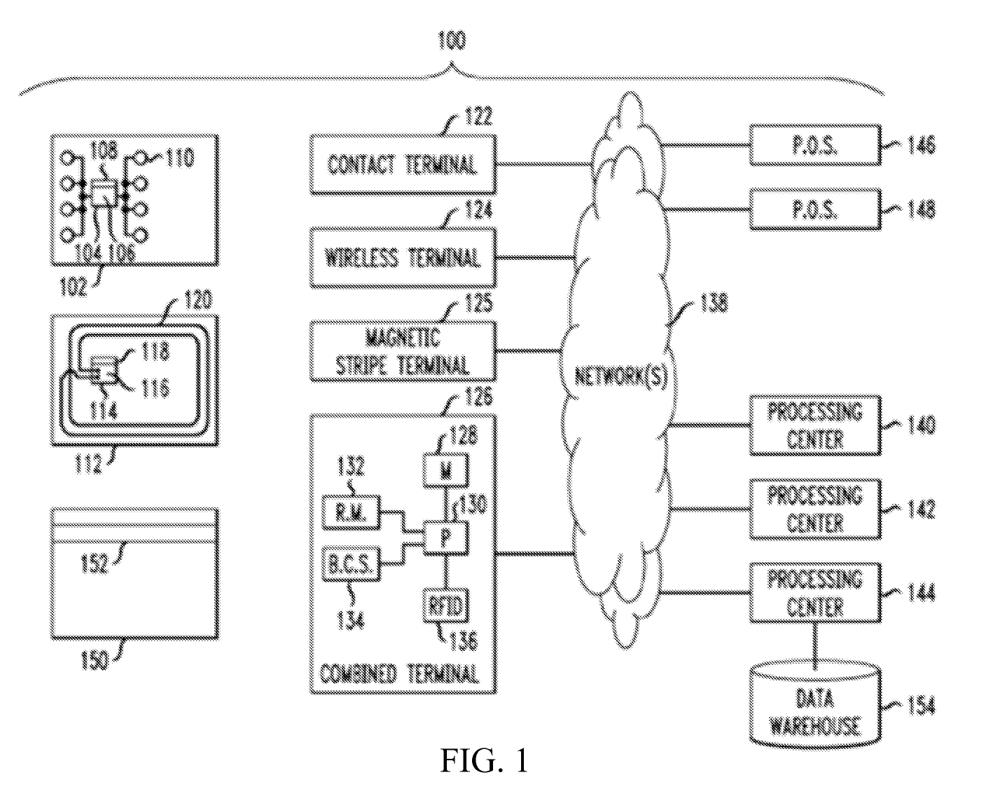

FIG. 1 depicts a system 100 including various possible components according to aspects of the present disclosure. It should be noted that for completeness and generality, presentation of certain physical cards such as known credit or debit cards to certain terminals will be described. However, aspects of the present disclosure involve credit accounts and transaction data that is not dependent on a physical card or terminal, for example. In FIG. 1, the system 100 includes a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed for communicating transaction data according to aspects of the present disclosure. Other types of devices used in lieu of or in addition to “smart” or “chip” cards 102, 112 could include a conventional card 150 having a magnetic stripe 152, an appropriately configured cellular telephone handset, and the like. Indeed, techniques can be adapted to a variety of different types of cards, terminals, and other devices, configured, for example, according to a payment system standard (and/or specification).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store protected transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used is the MULTOS® operating system licensed by MAOSCO Limited (MAOSCO Limited, St. Andrews House, The Links, Kelvin Close, Birchwood, Warrington, WA3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

As noted, cards 102, 112 are examples of a variety of payment devices that can be employed. The primary function of the payment devices may not be payment, for example, they may be cellular phone handsets. Such devices could include cards having a conventional form factor, smaller or larger cards, cards of different shape, key fobs, personal digital assistants (PDAs) or tablets, appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to implement appropriate functionality. The applications can be, for example, application identifiers (AIDs) linked to software code in the form of firmware plus data in a card memory such as an electrically erasable programmable read-only memory (EEPROM). Again, note that “smart” or “chip” cards are not necessarily required and a conventional magnetic stripe card can be employed; furthermore, as noted above, one or more embodiments are of interest wherever credit is extended in a credit account, including accounts having no physical card.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the BANKNET® virtual private network (VPN) of MasterCard International Incorporated of Purchase, N.Y., USA). More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device (or processing functionality of other entities discussed in other figures herein). Issuers can include issuers for cardless credit card accounts as well.

Many different retail or other establishments, as well as other entities, generally represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to implement appropriate functionality. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone or tablet.

Again, conventional magnetic stripe cards 150 can be used instead of or together with “smart” or “chip” cards, and again, cards and other payment devices are described for completeness, as one or more embodiments are of particular interest in the context of card-not-present Internet transactions.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices, for example. In operation, card 112 can be touched or tapped on the terminal 124 or 128, which then transmits the electronic data to the proximity IC chip in the card 112 or other wireless device. Magnetic stripe cards can be swiped in a well-known manner. In some instances, the card number is simply provided via web site, in a card-not present transaction or the like.

One or more of the processing centers 140, 142, 144 can include a database such as a data warehouse 154; for example, to hold transaction data as described below. It should be understood by persons skilled in the relevant arts that a database or data warehouse 154 may be directly linked to the one or more processing centers 140, 142, 144 or may be linked to the processing centers via the network(s) 138, for example.

In the context of card-not-present Internet transactions, the card or other device is not presented to terminal 122, 124, 125, or 126. Rather, appropriate account information (e.g., primary account number (PAN), cardholder name, cardholder address, expiration date, and/or security code, and so on) is provided to a merchant by a consumer using a web site or the like. The merchant then uses this information to initiate the authorization process.

According to aspects of the present disclosure, dynamic spend ranges are generated based on the transaction data. The transaction data in the data warehouse 154 may include different categories, such as consumer credit card transaction data, consumer debit card transaction data and commercial credit card transaction data, for example. The transaction data may include data descriptive of transactions in various different countries and/or regions, for example. The transaction data may indicate transaction amounts, location, product or service types, a transaction product segment or categories, and numerous other transaction classifications, for example.

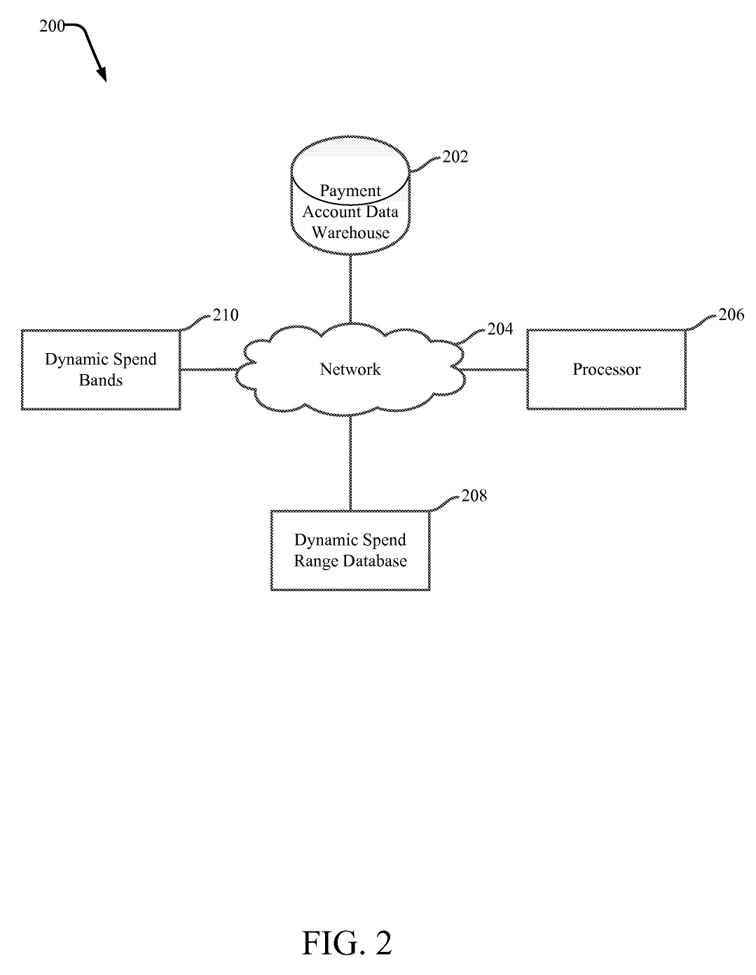

Referring to FIG. 2, a system 200 for producing dynamic spend ranges is disclosed. The system 200 may include a payment account data warehouse 202, a network 204, a processor 206, a dynamic spend range database 208, and an output 210.

The payment account data warehouse 202 may be directly coupled to the processor 206 or may be coupled to the processor 206 through a network 204. The warehouse 202 is configured to store transaction data relating to various payment card accounts, such as, issuer of the account, balance of the account, amounts spent using the account, location of purchases, and type of product or service purchased, for example.

The network 204 may include, for example, the Internet, and/or a proprietary network (for example, a virtual private network, such as the BANKNET® virtual private network (VPN) of MasterCard International Incorporated of Purchase, N.Y., USA). Additionally, more than one network 204 may be employed to connect different elements of the system 200.

The processor 206 may be configured to compute dynamic spend ranges using the data housed within the payment account data warehouse 202. The data used from the payment account data warehouse 202 may include a subset of the entirety of the data housed therein. Such subsets may include, for example, active accounts (e.g., consumer and/or commercial), transactions occurring within a certain temporal period, such as the previous year, transactions occurring within a specific geographic location, and/or accounts issued in specific geographic locations. These geographic parameters may be narrowed to areas such as continents, countries, states, cities, and any other location that can be adequately filtered using the data stored within the payment account data warehouse 202.

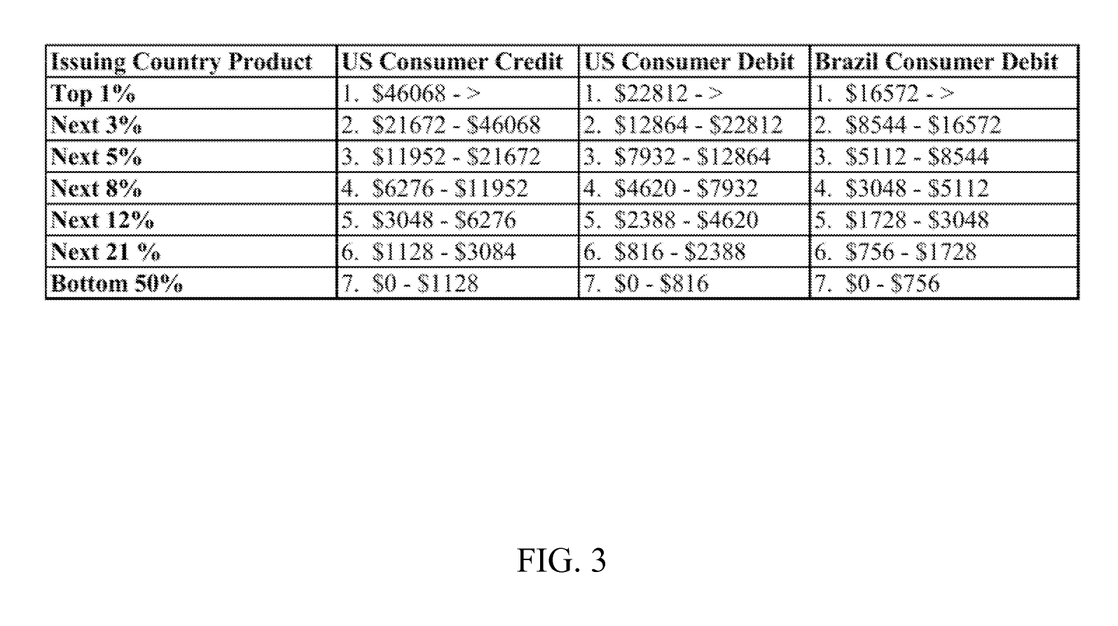

The post computation data stored within the dynamic spend range database 208 may be organized by segmentation or category such as type of payment device/product (e.g., credit, debit, etc.), geographic location of the issued account, or any other categorization supported by the data used from the payment account data warehouse 202. With reference to FIG. 3, such categories may include U.S. consumer credit, U.S. consumer debit, U.S. commercial credit, and/or consumer or commercial credit or debit in other countries. Within one or more of these categories, the processor 206 computes dynamic spend ranges. These spend ranges may be dynamically generated for a selected country or region as percentiles of spending within one or more selected categories over a selected time period (e.g., the past year) by a selected account type, e.g., each portable consumer device (“PCD”) account, for example. In one example, the percentage ranges may include the annual spend amount range in the top 1% of accounts by spend amount, next 3%, next 5%, next 8%, next 12%, next 21%, and bottom 50%. However, other percentage ranges may be dynamically selected without deviating from the present disclosure. For example, percentile ranges corresponding to spending deciles for a selected category and country or region may be dynamically generated according to aspects of the present disclosure. The processor may also be configured to fill gaps between the selected percentile ranges, resulting in no gaps between the upper amount of one percentile range and the lower amount of another percentile range. This dynamic adjustment of the spend bands to fill gaps between actual spend amounts ensures that any spend amount will fit into one of the dynamically spend bands even if gaps existed between spend bands in the original data, for example. In the example shown in FIG. 3, the lower threshold of the U.S. consumer credit top 1% band is $46,068 and the upper threshold of the U.S. consumer credit next 3% band is $46,068. As shown in FIG. 3, this relationship exists throughout the U.S. Consumer Credit rank until the lower limit of amount spent equals $0.

According to another aspect of the present disclosure, the processor 206 may be further configured to auto-format the dynamic spend ranges using an auto-format library. The auto-format library may be created using Rich Site Summary (RSS) procedures, for example. The auto-format library is generated by computing spend amounts for individual cardholders in a given market and product. The individual cardholders are then ranked based on their spend amounts. Percentile distributions are automatically generated based on the rankings and/or spend amounts. Actual spend amounts by individual cardholders at specific percentile breakpoints may be extracted to facilitate automatic formatting of the percentile distributions for specific countries and/or products. This process may be repeated across numerous countries and products to generate entire auto-format library. The auto-format library may be refreshed or updated periodically. With reference to FIG. 3, a cardholder in the U.S. consumer credit top 1% band spends $46,068 or more per year. When another cardholder spends, for example, $50,000 in the same year, the processor 206 uses the library of auto-formats to identify the $50,000 with the “$46,068 or greater” spend band, thus fitting the newly acquired data to the previously calculated data. The processor may be further configured to transmit this computed data to the dynamic spend range database 208.

The dynamic spend bands 210 may be stored within the dynamic spend range database 208 and/or may be presented in a table, such as that depicted in FIG. 3, for example. According to aspects of the present disclosure, the dynamic spend bands can improve traditional portfolio optimization strategies by providing up-to-date insight into spending patterns so banks and lenders may compare the spending levels of their clientele over varying markets and geographic areas.

FIG. 3 illustrates a table 300 of spending bands generated according to aspects of the present disclosure showing the U.S. consumer credit top 1% spends at least $46,068 per year, and the top 1% of U.S. consumer debit at least $22,812 per year. In comparison, the table shows that the top 1% of consumer debit card spending in Brazil is at least $16,572. This information is valuable to evaluate the purchase potential of different types of spend (e.g., credit and debit) and the purchase potential based on geographic location. This allows recipients to determine how much credit to extend and where to extend credit based on criteria not previously available.

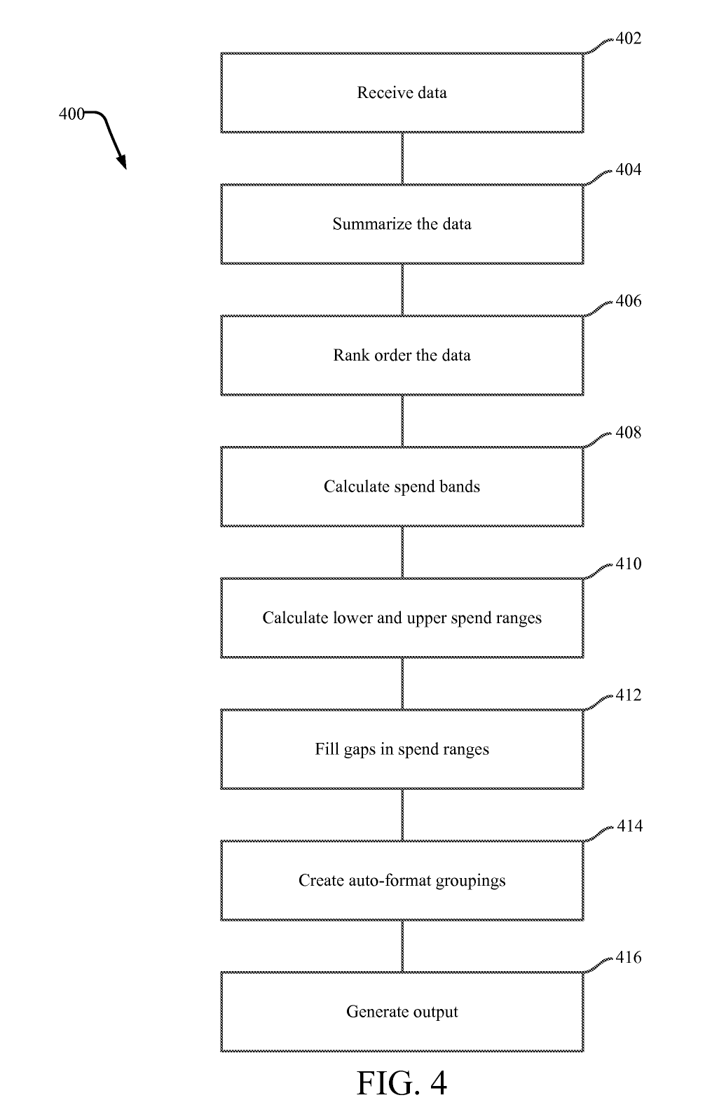

A method 400 of generating dynamic spend bands according to an aspect of the present disclosure is described with reference to FIG. 4. At block 402 transaction data is received from a database. The data may be proprietary or nonproprietary and may include information relating to PCD accounts, such as, issuer and balance of the account, amount spent using the account, geographic location of purchases, and the geographic area where the account was issued, for example. These PCDs may be issued to consumer and/or commercial entities, and may be credit cards, debit cards, or other types of PCD, for example.

At block 404 the received data is summarized to include transaction type, transaction amount, and location, for example.

At block 406 the transaction data is dynamically rank ordered/segmented into categories based upon, for example, the type of PCD (e.g., credit and debit) and geographic location of account issuance (e.g., continent, country, state, county, city, or any other relevant geographic location). For example, a U.S. consumer credit account, U.S. consumer debit account, and U.S. commercial account will all have their own ranking because they are all different types of payment accounts. For further illustration, a U.S. consumer credit account will have a different ranking than a Brazil consumer credit account because they are issued from different countries.

At block 408 the segmented data is ranked into spend bands. This entails calculating rank based upon spend (i.e., the amount of money spent by each PCD holder) Such rank may include the top 1%, next 3%, next 5%, next 8%, next 12%, next 21%, and bottom 50%. However, other ranges may be used without deviating from the present disclosure. At block 410 upper and lower spend ranges are calculated within each of the spend bands generated at block 408.

When the segmented data is ranked into spend bands, there may be a gap between the top spend amount in a spend band and the bottom spend amount in the next highest band. At block 412 gaps are filled between the upper and lower spend ranges created at block 410. According to an aspect of the present disclosure, the gaps may be filled by defining the bottom spend amount in one band as being equal to the top spend amount in the next lower band. In an alternative embodiment, the gaps may be filled by defining the bottom amount of a spend band as one dollar more than the top spend in the next lower spend band, for example. Upon completion, there should be no gaps between the upper amount of one spend range and the lower amount of another spend range. For example, the lower threshold of the U.S. consumer credit top 1% is $46,068 and the upper threshold of the U.S. consumer credit next 3% is $46,068. This relationship exists throughout the U.S. Consumer Credit rank until the lower limit of amount spent equals $0, i.e., the spend ranges are contiguous.

At block 414 auto-format groupings are created. This may entail using an auto-format library, which may be created using RSS procedures, to comport subsequently pulled data to the spend bands established at blocks 408, 410 ,412. For example, a U.S. consumer credit top 1% spends at least $46,068 in a year. When another payment account spends, for example, $50,000 in a year, the processor 206 uses the library of auto-formats to change the $50,000 to $46,068 or greater, thus fitting the newly acquired data to the previously calculated data.

The method 400 may also include block 416 where outputs are generated. These outputs may be presented in a table, for example.

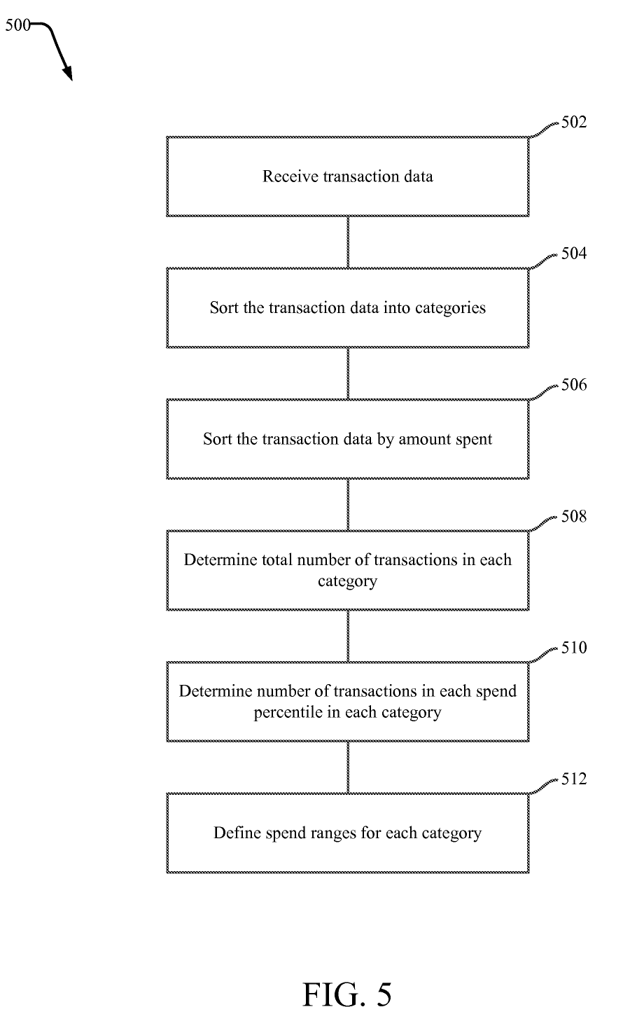

A method 500 for generating dynamic spend bands according to an embodiment of the present disclosure is described with reference to FIG. 5. At block 502 transaction data is received from a payment card network. This transaction data may include information relating to PCD accounts, such as, issuer and balance of the account, amount spent using the account, geographic location of purchases, and the geographic area where the account was issued. These PCDs may be issued to consumer and/or commercial entities, and may be credit, debit, or any other type of PCD known to those skilled in the art.

At block 504 the transaction data is segmented based upon type of transaction, for example. Such segmentation may be dependent upon the type of market the transaction deals with or the type of product being purchased in the transaction, for example. For illustration, a type of market may include a geographic location (e.g., continent, country, state, county, city, or any other relevant geographic location). At block 506 the entirety of the transaction data within each segment is sorted by the amount spent per transaction.

At block 508 the total number of transactions within each segment may be determined. At block 510 the number of transactions within each spend percentile in each category is determined. This may include dividing the number of transactions for each segment by 100.

At block 512 spend bands for each segment are determined. Such spend bands may include, for example, the top 1%, next 3%, next 5%, next 8%, next 12%, next 21%, and bottom 50%. However, other spend bands may be used without deviating from the present disclosure. Determine the spend bands may also include calculating an upper and lower spend range within each of the spend bands. This may include filling gaps between the spend bands so that no gaps exist between the upper amount of one spend band and the lower amount of another spend band.

For example, the lower threshold of the U.S. consumer credit top 1% is $46,068 and the upper threshold of the U.S. consumer credit next 3% is $46,068. This relationship exists throughout the U.S. consumer credit rank until the lower limit of amount spent equals $0.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teaching of the present disclosure.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although aspects of the present disclosure are described in terms of various types of payment cards and payment card accounts, it should be understood that the disclosure is not limited to physical cards or accounts associated with physical cards. For example, various payment devices, such as smart phones, tablet computers, and other wireless devices may be used in place of a payment cards within the scope of the present disclosure. It should be understood that any such payment device can be used in the same way as a payment card according to aspects of the present disclosure.

Although the present disclosure has been described in connection with the embodiments of the present disclosure illustrated in the accompanying drawings, it is not limited thereto. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although specific components have been set forth, it will be appreciated by those skilled in the art that not all of the disclosed components are required to practice the disclosed configurations. Moreover, certain well known components have not be described, to maintain focus on the disclosure.

For firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disc storage, magnetic disk storage or other magnetic storage devices, or other medium that can be used to store desired program code in the form of instructions or data structures and that can be accessed by a computer. Disk and disc, as used herein, includes compact disc (CD), laser disc, optical disc, digital versatile disc (DVD), floppy disk, and blu-ray disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative or instructions and data. The instructions and data are configured to cause one or more processors to implement the functions outlined in the claims.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps presently existing or later to be developed that perform substantially the same functions or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A system comprising:
a memory;
at least one processor operatively coupled to the memory; and
a persistent storage device operatively coupled to the memory and storing in a non-transitory manner instructions that when loaded into the memory cause the at least one processor to be operative to:
retrieve payment account data from a database, the payment account data including amount spent by each of at least two accounts;
organize the payment account data into segments using common characteristics including account type and issuance location;
calculate spend bands for each of the segments using the amount spent by each of the at least two accounts; and
create auto-format groupings for the spend bands, the groupings adjusting subsequently received transaction data to comport with the spend bands.

2. The system of claim 1 wherein the spend bands are represented as percentiles.

3. The system of claim 2 wherein the spend bands include top 1%, next 3%, next 5%, next 8%, next 12%, next 21%, and bottom 50%.

4. The system of claim 1 wherein the account type includes credit and debit.

5. The system of claim 1 wherein the account type includes consumer and commercial.

6. The system of claim 1 wherein the spend bands within each of the segments is gapless.

7. The system of claim 1 wherein the issuance location is selected from the group consisting of continent, country, state, county, and city.

8. A method of generating dynamic spend bands comprising:
receiving payment account data from a database, the payment account data having common characteristics including account type and issuance location;
ranking the payment account data into segments using the common characteristics;
calculating spend bands within each of the segments based upon amount spent per payment account; and
creating auto-format groupings using the spend bands, the auto-format groupings adjusting subsequently received transaction data to comport with the spend bands.

9. The method of claim 8 wherein the spend bands within each of the segments are gapless.

10. The method of claim 8 wherein the account type includes credit and debit.

11. The method of claim 8 wherein the issuance location includes a geographic location selected from the group consisting of continent, country, state, county, and city.

12. The method of claim 8 wherein the payment account data includes data from the past calendar year.

13. The method of claim 8 wherein the account type includes commercial and consumer.

14. A method for generating dynamic spend bands comprising:
receiving transaction data from a payment card network;
sorting the transaction data into segments based upon transaction type;
sorting the transaction data by amount spent within each of the segments;
determining a number of transactions within each spend percentile in each of the segments; and
defining spend bands for each segment.

15. The method of claim 14 wherein the transaction type includes a geographic region.

16. The method of claim 14 wherein the transaction type includes a type of product purchased.

17. The method of claim 14 wherein the transaction type includes credit and debit.

18. The method of claim 14 wherein the spend bands are gapless within each of the segments.

19. The method of claim 14 wherein the transaction type includes commercial and consumer.

20. The method of claim 15 wherein the geographic region is selected from the group consisting of continent, country, state, county, and city.
